(19) United States
(12) Patent Application Publication
(10) Pub. No.: US 2023/0121593 A1
(43) Pub. Date: Apr. 20, 2023

(54) DIFFERENTIAL BRAKING TO REDUCE STEERING EFFORT DURING ELECTRIC POWER STEERING LOSS OF ASSIST

(71) Applicants: Steering Solutions IP Holding Corporation, Auburn Hills, MI (US); Continental Automotive Systems, Inc., Auburn Hills, MI (US)

(72) Inventors: JOSEPH A. LABARBERA, BIRCH RUN, MI (US); CLINTON L. SCHUMANN, HOLLY, MI (US); SCOTT T. SANFORD, SWARTZ CREEK, MI (US); MICHAEL WYCIECHOWSKI, GRAND BLANC, MI (US)

(21) Appl. No.: 17/504,399

(22) Filed: Oct. 18, 2021

(51) Int. Cl. B60T 8/24; B60T 8/171; B60T 8/94

(52) U.S. Cl. CPC B60T 8/246; B60T 8/171; B60T 8/94; B60T 2250/03; B60T 2260/024; B60T 2250/04

(57) ABSTRACT

A number of variations are discloses including a system and method including using differential braking to reduce steering effort during loss of assist.

### TECHNICAL FIELD

The field to which the disclosure generally relates to includes steering, braking, and propulsion systems.

### BACKGROUND

Vehicles typically include steering systems including electric power steering systems.

### SUMMARY OF ILLUSTRATIVE VARIATIONS

A number of variations may include a system and method including using differential braking to reduce steering effort during loss of assist.

A number of variations may include a method including monitoring the heath of a steering system comprising an electric steering assist, determining if the electric steering assist has failed, monitoring a driver steering interface to determine the steering angle and torque applied to the steering interface by the driver, and if electric steering system assist has failed then applying brake force or brake torque to one or more roadwheel brakes to counter an aligning force of steering roadwheels due to the failed electric steering assist and so that the torque applied by the driver to steer is less than the torque required to be applied by the driver in the absence of applying brake force or brake torque.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 depicts an illustrative variation of a block diagram of a system and method of brake-to-steer functionality as steering system assist failure fallback;

FIG. 2 depicts an illustrative variation of a vehicle equipped with hardware sufficient for carrying out at least some of the systems and methods described herein;

FIG. 3 depicts an illustrative variation of a system or method including pre-charging a brake system;

FIG. 4 is an illustration, in graph form, of in-vehicle data how differential braking reduces driver steering effort in a loss of assist event.

### DETAILED DESCRIPTION OF ILLUSTRATIVE VARIATIONS

The following description of the variations is merely illustrative in nature and is in no way intended to limit the scope of the invention, its application, or uses.

A number of variations may include systems and methods using steering wheel and vehicle state information as inputs to a brake-to-steer system at the onset of an electric power steering failure. The brake steer system could be used to reduce the vehicles steering rack loads, thus reducing driver effort, during situations where the electric power steering motor or electric power steering control module is not operational.

A number of variations may be constructed and arranged to address the loss of steering assist in an electric power steering system when the electric power system power pack or electric motor fails. The failure of the electric power system steering assist can result in a large increase in steering effort, especially in situations where the road wheels are at a high angle and steering rack loads are high, resulting in a release of energy when all electric power steering assist force suddenly vanishes. When the power assist fails differential braking may provide lateral capabilities as a unique, diverse support method using a different actuator, such as the brakes, that may be used to manage the force of steering road wheels that naturally tend to move to a zero angle with respect to the longitudinal direction of the vehicle.

In a number of variations when the electric power steering or the electric motor is rendered inoperative, the brake-to-steer system may implement an algorithm that provides brake force or brake torque request to individual roadwheels as a function of vehicle state information which may include at least one of lateral acceleration, yaw rate, wheel speed, or other vehicle state information, and if available, steering sensor measurements such as at least one of torque or angle. Furthermore, estimations of lateral acceleration, yaw rate, steering angle may be derived from inputs from gps, cameras, lidars, and radars may be used in the algorithm, executable by at least one electronic processor, to provide the brake force or brake torque request. The brake force or brake torque requests may be calculated in such a way as to provide enough braking force on the road wheel to counter the aligning torque the driver is resisting while steering the vehicle with a steering assist failure. The application of differential braking will ultimately reduce steering rack loads and reduce necessary driver effort during a loss of assist event. In number of variations, one the steering system is incapable of providing steering input from the driver, an external steering column angle sensor may be used to indicate driver intent. For example, a video system including object recognition capabilities, or an infrared transmitter/receiver system may be utilized to identify features of the driver interface such as a steering wheel and determine movement of the driver interface as the driver's intent to achieve a certain steering angle. An external steering column angle sensor may be provided in a variety of locations in the vehicle including, but not limited to, the instrument panel or the dashboard of the vehicle.

A number of variations may be constructed and arranged to be utilized in the following sequence of events. First, the driver maybe driving a vehicle with a normally functioning electric power steering system and during a turn the electric power system controller or electric power system motor fails or shuts down so that it provides no motor output that can assist the driver in steering the vehicle. The driver may hold or rotate the steering interface to maintain the vehicle curvature or direct the vehicle in a new direction. Lateral acceleration, yaw rate, and vehicle speed data may be sent to the brake-to-steer loss of assist support controller, and if available, signals regarding the steering angle, steering wheel rate, and steering torque are sent to the brake-to-steer loss of assist support controller. At the same time, the loss of assist controller running the brake-to-steer loss of assist support algorithm, or a brakes electric control unit, instantly sends pressure requests as a function of the aforementioned signals to the brakes electric control unit, which distributes the pressure request to all four wheels. The steering effort due to loss of assist is now reduced due to the differential braking forces' reduction of steering rack loads. The driver's intended vehicle speed may be maintained as much as possible, but in general the vehicle gradually slows down due to the differential braking. The differential braking and the vehicle speed may be maintained for long enough for the driver to bring the vehicle to a safe state, but can also remain active to support the driver steering for extended periods of time.

In a number of illustrative variations, a steering interface may comprise a handwheel, a joystick, a trackball, a slider, a throttle, a pushbutton, a toggle switch, a lever, a touchscreen, a mouse, or any other known means of user input.

In a number of illustrative variations, a vehicle may comprise a steering system comprising a steering interface and a steerable propulsion system such as, but not limited to, a steering wheel and road wheels, respectively.

In a number of illustrative variations, a vehicle may include electric braking system constructed and arranged to apply brake force or brake torque to any number of road wheels to assist in steering a vehicle based upon driver steering interface input. The electric braking system may be in operable communication with the steering system and road wheel actuator assembly via at least one controller. The controller may implement any number of systems, including algorithms, for monitoring and controlling propulsion, steering, and braking. According to some variations, the electric braking system may be utilized to apply differential brake force or brake torque to a number of wheels to effectuate lateral motion of the vehicle where a portion of a electric power steering system assist has failed.

In a number of illustrative variations, a brake-to-steer system may utilize a brake-to-steer algorithm that may communicate brake force or brake torque requests to individual wheels as a function of driver steering inputs including steering angle, steering angle rate, and steering torque. The brake-to-steer algorithm may communicate brake force or brake torque requests when the system has detected a power steering assist failure or shut down.

Upon detection of steering assist failure, the system may generate a visual or audio cue to a driver via a human to machine interface integrated into the vehicle. As a non-limiting example, the system may indicate via lamps or alarms that the steering assist has failed. Driver input into the handwheel in the form of steering signals may include steering wheel angle, steering wheel rate, and steering torque may be communicated to a brake-to-steer driver directional controller. The brake-to-steer algorithm may receive said steering signals and calculate brake force or brake torque requests as a function steering signals to an electric braking system electric control unit. An electric braking system may provide a response to driver input of steering signals to reduce the amount of torque the driver must use to steer the vehicle when there is a loss of steering assist. In some cases, the system may provide for control of a vehicles propulsion system and may adjust throttle, speed, acceleration, and the like as needed to maintain driving speed while the brake-to-steer system is operating. In some cases, the system may control a vehicles propulsion system to facilitate gradual slowing of a vehicle while the brake-to-steer system is operating.

According to some variations, a brake-to-steer system may be controlled by an external domain controller constructed and arranged to employ brake-to-steer functionality where a steering system fails entirely.

According to some variations, the brake-to-steer system may function by converting steering requests into a desired yaw rate which may then be converted into a corresponding brake force or brake torque applied to the vehicle brakes in order to create the desired yaw rate with the driver controlling the steering wheel. Brake force or brake torque may be applied to vehicle brakes via an electric braking system. Brake force or brake torque may be applied to individual brake calipers as required.

Converting steering requests to actual yaw rate, and the conversion from your rate to brake force or brake torque may be accomplished via calculation or look up tables. Similarly, converting steering angle to the appropriate brake force or brake torques may also be accomplished via calculation or look up table.

According to some variations, the brake-to-steer system may continuously monitor vehicle speed, yaw rate, and lateral acceleration and may broadcast the availability of the brake-to-steer functionality to various other systems within the vehicle such that, if needed, brake-to-steer functionality may be implemented readily. According to some variations, the availability of the brake-to-steer system may include factoring in vehicle velocity data to determine the availability of the brake-to-steer system.

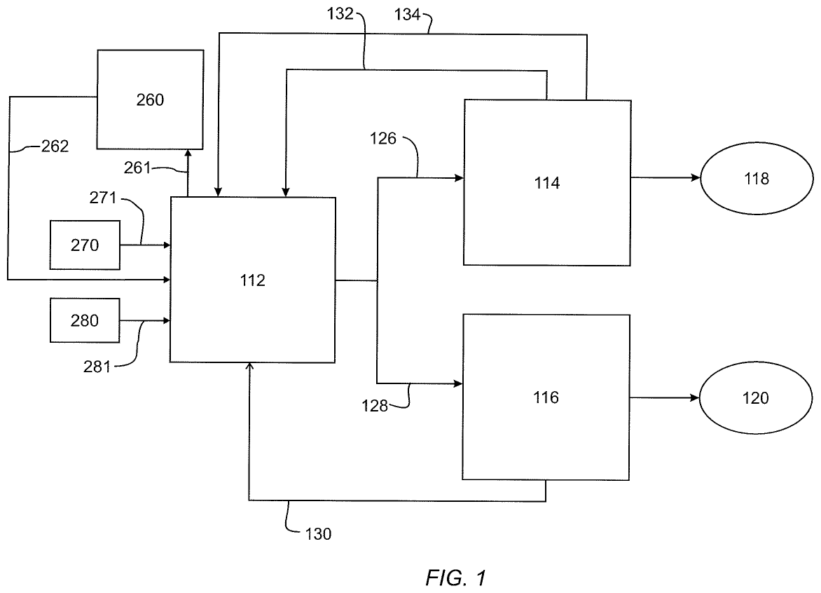

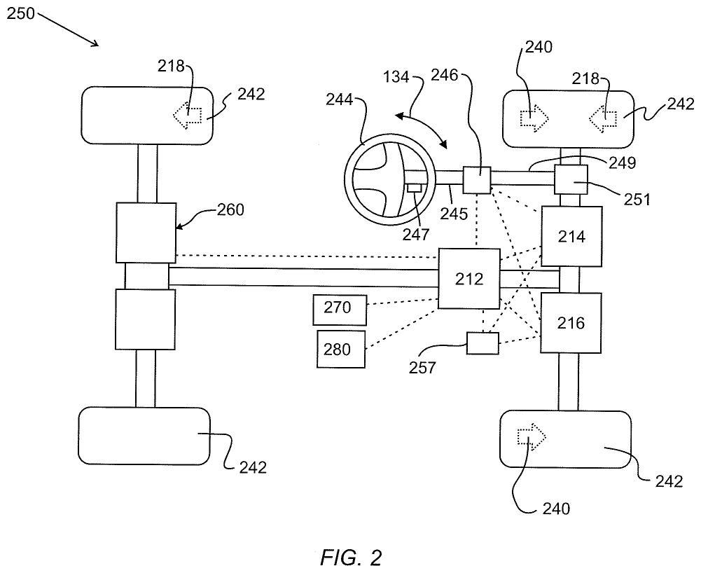

FIG. 1 depicts an illustrative variation of block diagram of a system and method of brake-to-steer as steering assist failure fallback. A vehicle may include a controller 112 constructed and arranged to receive driver steering input 134 via a steering system 114. The controller 112 may additionally be constructed and arranged to provide steering actuator commands 126 to the steering system 114. The steering system 114 may output tire angle changes 118 to affect steering system health status 132 to the controller 112. The controller 112 may also be constructed and arranged to provide braking commands 128 to an electric braking system 116 which, in turn, may apply brake force or brake torque 120 to individual brake calipers. Where the steering system 114 has indicated to the controller 112 that steering system health status 132 as failed, the controller 112 may send a brake movement request to provide differential braking at all roadwheels. If the steering system 114 indicates that a power steering assist has failed, the controller 112 may receive driver input 134 via a steering wheel and convert steering requests into brake force or brake torque requests or commands 128 to be communicated to the electric braking system 116. The controller 112 may also receive input 271 from a variety of devices 270 designed to measure vehicle state information including, but not limited to lateral acceleration, yaw rate, wheel speed. The controller may receive input 281 from a variety of devices 280 that may include, but not limited to, gps, cameras, lidars, and radars that may be used in the algorithm to estimate a variety of vehicle states. The estimated vehicle states may be helpful, for example but not limited to, when steering wheel angle, torque, velocity sensors are not available. The controller 112 may receive input and send output to a propulsion system. FIGS. 1-2 are simply illustrative. The functionality of the controller(s) may be carried out by one or more controllers situated anywhere in the vehicle. One or more algorithms may be used and executed by one or more processors to accomplish the methods, actions and functionality described herein.

FIG. 2 depicts an illustrative variation of portions of a vehicle equipped with hardware sufficient for carrying out at least some of the systems and methods described herein. A vehicle 250 may include a controller 212 constructed and arranged to provide brake-to-steer functionality in a vehicle 250. The controller 212 may be in operable communication with a steering system 214 and an electric braking system 216. The steering system 214 and an electric braking system 216 may be in operable communication with at least one road wheel 242. A driver may utilize a handwheel 244 to provide driver input 134 for lateral movement and send steering requests to the steering system 214. In some variations, a steering assist 246 associated with the steering interface 244 may be in operable communication with the controller 212, the steering system 214, or the electric braking system 216. In some variations, the steering assist 246 may be disconnected or in a failure state from or unable to communicate with the steering system 214. In such a variation, the steering sensor 247 may communicate steering requests to the controller 212, which may receive steering system 214 health status information. Where the controller 212 has received steering system 214 health status information indicative of a component, such as a steering assist 246 has failed, the controller 212 may convert steering requests from the steering sensor 247 to brake force or brake torque requests to be communicated to the electric braking system 216. The electric braking system 216 may apply brake force or brake torque 218 to determined appropriate roadwheels 242 to effectuate lateral movement of the vehicle as input 134 by the driver via the handwheel 244. The controller 212 may also be constructed and arranged to make speed and acceleration requests 240 to a propulsion system onboard such that the vehicle may maintain or modify speed or acceleration during the use of brake-to-steer functionality to provide steering assist to the driver. If the steering sensor 247 is not operational, an external steering angle sensor 257 may be provided at another location in the vehicle and communicate the driver's steering intent which may be used by the controller in the same manner with respect to the steering sensor regarding steering angle. Again, the controller 112 may also receive input 271 from a variety of devices 270 designed to measure vehicle state information including, but not limited to lateral acceleration, yaw rate, wheel speed. The controller may receive input 281 from a variety of devices 280 that may include, but not limited to, gps, cameras, lidars, and radars that may be used in the algorithm to estimate a variety of vehicle states. The estimated vehicle states may be helpful, for example but not limited to, when steering wheel angle, torque, velocity sensors are not available. The controller 112 may receive input and send output to a propulsion system.

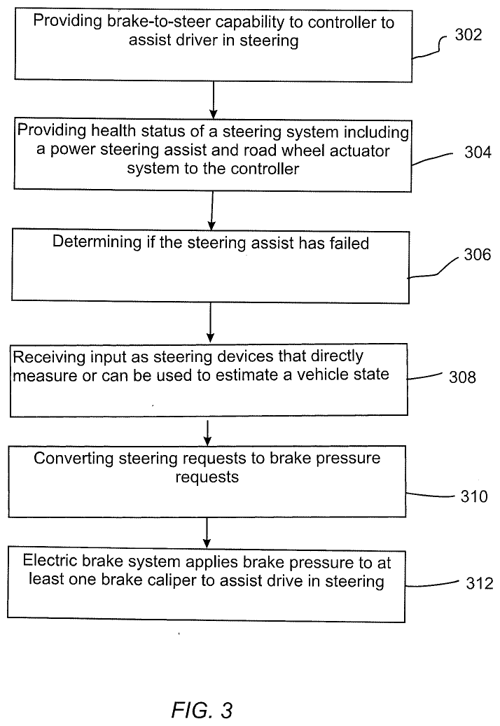

FIG. 3 depicts a simplified flowchart of an illustrative variation of a system for using brake-to-steer functionality as a steering assist failure fallback. The system may routinely or approximately continuously provide brake-to-steer capability to a controller 302 indicating readiness of the brake-to-steer functionality. At point 304, the steering system health status, including steering assist health status, may be communicated to the motion controller. In some instances, the health status may indicate that portions of the steering assist are at risk of failing, failing, is malfunctioning or not operable. At point 306, the controller may receive the steering system health status and determine that the steering has failed. At point 308, then controller receives drive input as steering requests. The input may come from a steering sensor if available or other devices that measure or may be used to estimate a vehicle state such as, but not limited to, lateral acceleration, yaw rate or wheel speed. At point 310, the controller may convert steering requests to brake force or brake torque requests. Alternatively, the system may convert steering requests to vehicle yaw rate requests and convert yaw rate requests to brake force or brake torque requests. At point 312, the electric brake system may receive brake force or brake torque requests and apply brake force or brake torque to individual brake calipers on a vehicle in order to assist in steering or to steer the vehicle.

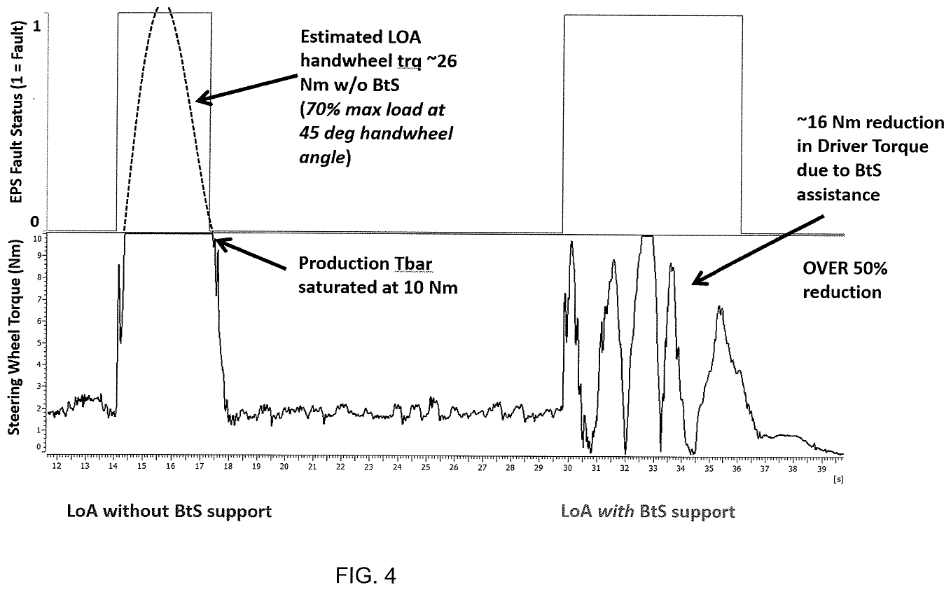

FIG. 4 is an illustration of, in graph form, in-vehicle data how differential braking reduces driver steering effort in a loss of assist event.

The following description of variants is only illustrative of components, elements, acts, product, and methods considered to be within the scope of the invention and are not in any way intended to limit such scope by what is specifically disclosed or not expressly set forth. The components, elements, acts, product, and methods as described herein may be combined and rearranged other than as expressly described herein and still are considered to be within the scope of the invention.

Variation 1 may include a method including using differential braking to reduce steering effort during loss or electric power assist of a steering system of a vehicle.

Variation 2 may include a method including monitoring the heath of a steering system comprising an electric steering assist, determining if the electric steering assist has failed, monitoring a driver steering interface to determine the steering angle and torque applied to the steering interface by the driver, and if electric steering system assist has failed then applying brake force or brake torque to one or more roadwheel brakes to counter an aligning force of steering roadwheels due to the failed electric steering assist and so that the torque applied by the driver to steer is less than the torque required to be applied by the driver in the absence of applying brake force or brake torque.

Variation 3 may include a method for use in a vehicle having a controller, a steering system including an electric power assist and a steering sensor, an electric brake system, roadwheels, and a propulsions system, the method comprising: using the brake system to apply differential braking to the roadwheels when the electric power assist has failed.

Variation 4 may include a method as set forth in variation 3 wherein using the brake system to apply differential braking to the roadwheel comprises applying an amount of brake force or brake torque to at least one of the roadwheels to reduce the effort a driver uses to steer the vehicle when the electric power assist has failed.

Variation 5 may include a method as set forth in variation 3 further comprising the causing the propulsion system to provide a forward driving force to at least partial compensate for the differential braking.

Variation 6 may include a method as set forth in variation 3 further comprising determining if the steering sensor has failed and if the steering sensor has failed using a steering angle sensor external to the steering system to determine estimate a steering angle and applying differential braking to the roadwheel based at least in part on the estimated steering angle.

Variation 7 may include a method as set forth in variation 4 wherein the amount of braking pressure applied to one or more of the roadwheels is based at least in part on at least one of one of lateral acceleration or yaw rate of the vehicle.

Variation 8 may include a method as set forth in variation 4 wherein the amount of braking pressure applied to one or more of the roadwheels is based at least in part on at least one of steering interface torque or angle.

Variation 9 may include a method as set forth in variation 4 wherein the amount of braking pressure applied to one or more of the roadwheels is based at least in part on the steerable roadwheel aligning torque when the power steering assist has failed.

Variation 10 may include a method including monitoring the heath of a steering system comprising an electric steering assist, determining if the electric steering assist has failed, monitoring a driver steering interface to determine the steering angle and torque applied to the steering interface by the driver, and if electric steering system assist has failed then applying brake force or brake torque to one or more roadwheel brakes to counter an aligning force of steering roadwheels due to the failed electric steering assist and so that the torque applied by the driver to steer is less than the torque required to be applied by the driver in the absence of applying brake force or brake torque.

Variation 11 may include a controller configured to cause differential braking to the roadwheels of a vehicle when an electric power steering assist of the vehicle has failed.

Variation 12 may include a controller as set forth in variation 11 wherein differential braking comprises applying an amount of brake force or brake torque to at least one of the roadwheels to reduce the effort a driver uses to steer the vehicle when the electric power assist has failed.

Variation 13 may include computer readable media including instructions executable by an electronic processor to carry out the actions comprising: determining if an electric power assist of a steering system of a vehicle has failed or receiving input indicating that the electric power assist of a steering system of a vehicle has failed; if the electric power assist of a steering system of a vehicle has failed, outputting brake force or brake torque request to a brake system to apply an amount of brake force or brake torque to at least one of the roadwheels to reduce the effort a driver uses to steer the vehicle when the electric power assist has failed.

The above description of select variations within the scope of the invention is merely illustrative in nature and, thus, variations or variants thereof are not to be regarded as a departure from the spirit and scope of the invention.

What is claimed is:

1. A method including using differential braking to reduce steering effort during loss or electric power assist of a steering system of a vehicle.

2. A method including monitoring the heath of a steering system comprising an electric steering assist, determining if the electric steering assist has failed, and if electric steering system assist has failed then applying brake force or brake torque to one or more roadwheel brakes to counter an aligning force of steering roadwheels due to the failed electric steering assist and so that the torque applied by the driver to steer is less than the torque required to be applied by the driver in the absence of applying brake force or brake torque.

3. A method for use in a vehicle having a controller, a steering system including an electric power assist and a steering sensor, an electric brake system, roadwheels, and a propulsions system, the method comprising: using the brake system to apply differential braking to the roadwheels when the electric power assist has failed.

4. A method as set forth in claim 3 wherein the using the brake system to apply differential braking to the roadwheel comprises applying an amount of brake force or brake torque to at least one of the roadwheels to reduce the effort a driver uses to steer the vehicle when the electric power assist has failed.

5. A method as set forth in claim 3 further comprising the causing the propulsion system to provide a forward driving force to at least partially compensate for the differential braking.

6. A method as set forth in claim 1 further comprising determining if the steering sensor has failed, and if the steering sensor has failed using a steering angle sensor external to the steering system to determine an estimate of a steering angle, and applying differential braking to the roadwheel based at least in part on the estimated steering angle.

7. A method as set forth in claim 4 wherein the amount of braking pressure applied to one or more of the roadwheels is based at least in part on at least one of lateral acceleration, yaw rate, or wheel speed of the vehicle, wherein the at least one of lateral acceleration, yaw rate, or wheel speed is measured or estimated.

8. A method as set forth in claim 4 wherein the amount of braking pressure applied to one or more of the roadwheels is based at least in part on at least one of steering interface torque or angle.

9. A method as set forth in claim 4 wherein the amount of braking pressure applied to one or more of the roadwheels is based at least in part on the steerable roadwheel aligning torque when the power steering assist has failed.

10. A method including monitoring the health of a steering system comprising an electric steering assist, determining if the electric steering assist has failed, monitoring a driver steering interface to determine the steering angle and torque applied to the steering interface by the driver, and if electric steering system assist has failed then applying brake force or brake torque to one or more roadwheel brakes to counter an aligning force of steering roadwheels due to the failed electric steering assist and so that the torque applied by the driver to steer is less than the torque required to be applied by the driver in the absence of applying brake force or brake torque.

11. A controller configured to cause differential braking to the roadwheels of a vehicle when an electric power steering assist of the vehicle has failed.

12. A controller as set forth in claim 11 wherein differential braking comprises applying an amount of brake force or brake torque to at least one of the roadwheels to reduce the effort a driver uses to steer the vehicle when the electric power assist has failed.

13. A computer readable media including instructions executable by an electronic processor to carry out the actions comprising: determining if an electric power assist of a steering system of a vehicle has failed or receiving input indicating that the electric power assist of a steering system of a vehicle has failed; if the electric power assist of a steering system of a vehicle has failed, outputting brake force or brake torque request to a brake system to apply an amount of brake force or brake torque to at least one of the roadwheels to reduce the effort a driver uses to steer the vehicle when the electric power assist has failed.

14. A method as set forth in claim 1 wherein the amount of braking pressure applied is based on a measuring or estimating at least one vehicle state.

15. A method as set forth in claim 14 wherein the at least one vehicle state comprises at least one of later acceleration or yaw rate.

16. A method as set forth in claim 14 wherein the estimating at least one vehicle state comprises using input to the controller from a device comprising at least one of a gps, camera, video, lidar, or radar device
